(19) United States
(12) Patent Application Publication
(10) Pub. No.: US 2025/0350688 A1
(43) Pub. Date: Nov. 13, 2025

(54) INFORMATION PROCESSING APPARATUS, INFORMATION PROCESSING METHOD, AND IMAGE FORMING APPARATUS

(71) Applicant: CANON KABUSHIKI KAISHA, Tokyo (JP)

(72) Inventor: SHUNSUKE IWANO, Kanagawa (JP)

(21) Appl. No.: 19/201,148

(22) Filed: May 7, 2025

(30) Foreign Application Priority Data
May 10, 2024 (JP) 2024-077292

(51) Int. Cl. H04N 1/00; G06T 7/00

(52) U.S. Cl. CPC H04N 1/00029; G06T 7/0008; G06T 7/001; H04N 1/00045; H04N 1/00074; G06T 2207/30144

(57) ABSTRACT

The present disclosure provides a technique for reducing a user's effort regarding whether to display read image data in a diagnosis report. Print job information including at least part of a print job subjected to diagnosis, and diagnosis result information are obtained. It is determined whether the obtained diagnosis result information is information obtained by a test chart image diagnosis or by a user image diagnosis based on image type information included in the obtained print job information. If the read image data is test chart image data, read image data is obtained which was compared with reference image data in the test chart image diagnosis performed to obtain the obtained diagnosis result information, and a diagnosis report with the read image is generated. If the read image data is user image data, not test chart image data, a diagnosis report without the read image is generated.

### BACKGROUND

### Field

The present disclosure relates to an information processing technique for diagnosing a state of an image forming apparatus from a product output therefrom.

### Description of the Related Art

There is an image diagnosis technique which involves providing an image forming apparatus with a printing unit and an image reading unit, reading a printed product printed by the printing unit with the image reading unit, and diagnosing whether the image forming apparatus has any malfunctioning parts that may be causes of defective images from the image data obtained by the reading. A diagnosis chart image or a user image prepared by a user can be used as the image printed on the printed product. Japanese Patent Laid-Open No. 2023-19941 discloses an example in which a combined image obtained superimposing a marking image indicating spots with defects over inspection source data is displayed in a diagnosis report generated based on the result of an image analysis. Here, the inspection source data is read image data obtained by reading a printed product.

Note that the inspection source data may be switched between read image data and processed data depending on the image printed on the printed product. In this case, the technique of Japanese Patent Laid-Open No. 2023-19941 requires the user's effort to individually set which type of data to use.

Thus, an object of the technique of the present disclosure is to reduce a user's effort regarding whether to display or not to display read image data in a diagnosis report.

### SUMMARY

The technique of the present disclosure includes: an obtaining unit that obtains read image data obtained by reading a printed product printed by a printing apparatus based on print image data included in a print job, and at least part of a print job; a diagnosis unit that makes a diagnosis on whether the printed product has a defect based on the read image data; and a generation unit that generates a diagnosis report indicating a result of the diagnosis based on the at least part of the print job obtained by the obtaining unit, and the diagnosis report includes the read image data in a case where the print image data is predetermined image data for detecting a print defect, and does not include the read image data in a case where the print image data is not the predetermined image data.

Further features of the present disclosure will become apparent from the following description of exemplary embodiments with reference to the attached drawings.

### BRIEF DESCRIPTION OF THE DRAWINGS

FIG. 1 is a diagram illustrating an example network configuration including a printing system;

FIG. 2 is a cross-sectional view illustrating an example hardware configuration of an image forming apparatus;

FIG. 3 is a block diagram illustrating internal configurations of the image forming apparatus, an external controller, and a client personal computer (PC);

FIG. 4 is a flowchart illustrating a procedure of a test chart image diagnosis process;

FIG. 5 is a flowchart illustrating a procedure of a user image diagnosis process;

FIG. 6 is a flowchart illustrating a procedure of a report generation process in the first embodiment;

FIG. 7 is a view illustrating an example of a test chart image used in the test chart image diagnosis process;

FIG. 8 is an example of a diagnosis result list screen;

FIG. 9A is an example of a diagnosis report in the first embodiment;

FIG. 9B is an example of a diagnosis report in the first embodiment;

FIG. 9C is an example of a diagnosis report in the first embodiment;

FIG. 9D is an example of a diagnosis report in the first embodiment; and

FIG. 10 is a flowchart illustrating a procedure of a report generation process in a second embodiment.

### DESCRIPTION OF THE EMBODIMENTS

Embodiments of the present disclosure will now be specifically described below with reference to the accompanying drawings. Note that identical components are denoted by the same reference numeral and description thereof is omitted.

### First Embodiment

### Configuration of Entire System

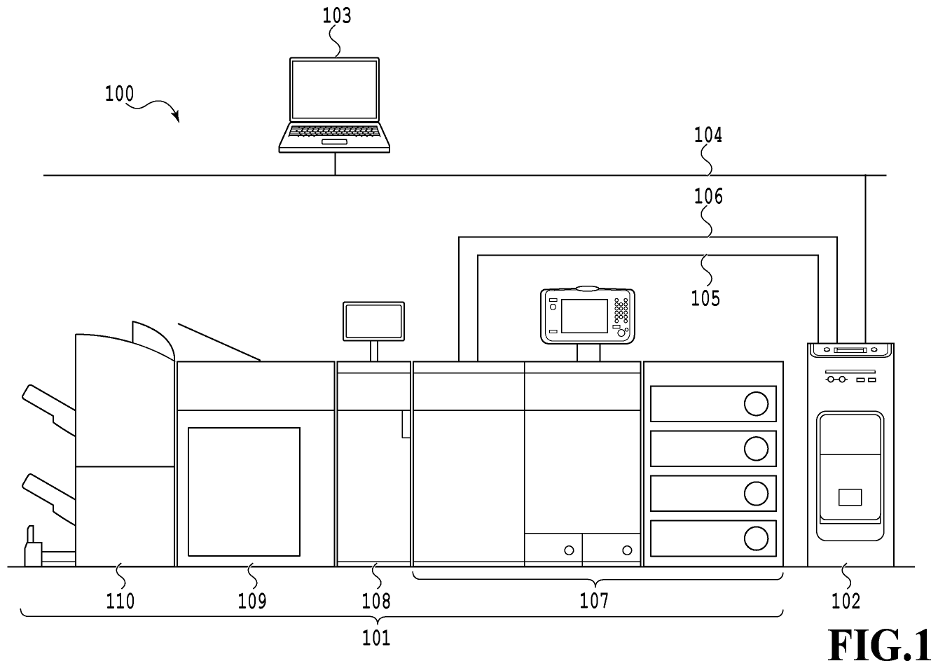

FIG. 1 is a diagram illustrating an example network configuration including a printing system (image processing system) according to a first embodiment. As illustrated in FIG. 1, a printing system 100 includes an image forming apparatus 101 and an external controller 102. The image forming apparatus 101 and the external controller 102 are communicatively connected to each other through an internal LAN local area network (LAN) 105 and a video cable 106. The external controller 102 is communicatively connected to a client PC 103 through an external LAN 104.

The client PC 103 is capable of instructing the external controller 102 to perform printing through the external LAN 104. In the client PC 103, a printer driver is installed which has a function of converting image data to be subjected to a printing process into a page description language (PDL) which the external controller 102 can process. By operating the client PC 103, a user who wants to perform printing can give a print instruction from various applications installed in the client PC 103 via the printer driver. Based on the print instruction from the user, the printer driver transmits PDL data being print data to the external controller 102.

In response to receiving the PDL data from the client PC 103, the external controller 102 analyzes and interprets the received PDL data. The external controller 102 performs a rasterizing process based on the result of the interpretation to generate a bitmap image (print image data) of a resolution adjusted to the image forming apparatus 101, and inputs a print job including the print image data into the image forming apparatus 101 to give a print instruction to it.

Next, the image forming apparatus 101 will be described. The image forming apparatus 101 is a combination of multiple apparatuses with different functions and configured to be capable of performing complicated printing processes, such as bookbinding. The image forming apparatus 101 has a printing unit 107 (image forming unit), a diagnosis unit 108, a stacker 109, and a finisher 110. Each module will now be described.

In accordance with an input print job, the printing unit 107 performs printing based on the print image data, and discharges the printed printing material. The printed printing material discharged from the printing unit 107 is conveyed through the inside of each apparatus in the order of the diagnosis unit 108, the stacker 109, and the finisher 110. In the present embodiment, the image forming apparatus 101 of the printing system 100 is an exemplary image forming apparatus and is not limited to it, and the printing unit 107 included in the image forming apparatus 101 may be referred to as “image forming apparatus.” The printing apparatus 107 forms (prints) an image using toners (color materials) on a printing material fed and conveyed from a sheet feed unit disposed at a lower portion of the printing unit 107. In the present embodiment, the printing unit 107 is an apparatus that performs electrophotographic printing but is not limited to this configuration, and may be an apparatus that performs printing by another method, such as an inkjet method, for example.

The diagnosis unit 108 is an apparatus that diagnoses whether the image forming apparatus 101 has any malfunctioning parts based on printed printing materials conveyed thereto through a conveyance path after image printing by the printing unit 107. Specifically, the diagnosis unit 108 reads the images printed on the printed printing materials conveyed thereto, and performs a diagnosis on the read image data thus obtained. The diagnosis unit 108 extracts a diagnosis region from the read image data, and diagnoses whether any malfunctions are present based on the differences between the pixel values of the print image data and the pixel values of the read image data in the extracted diagnosis region. Details of the processing by the diagnosis unit 108 will be described later. Note that the function of the diagnosis unit 108 is not limited to the above diagnosis function, and may additionally have an inspection function to inspect the presence of print defects on printed printing materials.

The stacker 109 is an apparatus in which many printed printing materials can be stacked. The finisher 110 is an apparatus which is capable of executing finishing processes, such as stapling, punching, and saddle stitch bookbinding, on printed printing materials conveyed thereto. The printing materials processed by the finisher 110 are discharged onto a predetermined sheet discharge tray.

In the configuration example illustrated in FIG. 1, the external controller 102 is connected to the image forming apparatus 101, but the present embodiment is applicable also to configurations different from this. For example, the present embodiment may employ a configuration in which the image forming apparatus 101 is connected to the external LAN 104, and print data is transmitted directly to the image forming apparatus 101 from the client PC 103 and not via the external controller 102. In this case, the image forming apparatus 101 executes the data analysis and rasterization on the print data.

### Hardware Configuration of Image Forming Apparatus 101

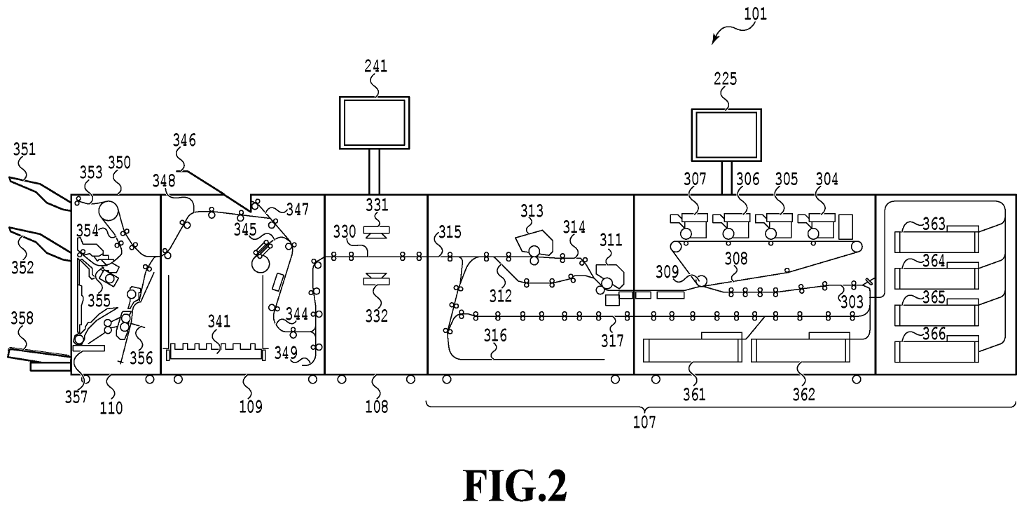

FIG. 2 illustrates an example hardware configuration of the image forming apparatus 101. A specific example of operation of the image forming apparatus 101 will now be described below with reference to FIG. 2.

### Description of Sheet Feed Decks

The printing unit 107 includes multiple sheet feed decks. In the present embodiment, the printing unit 107 includes six types of sheet feed decks, namely, sheet feed decks 361, 362, 363, 364, 365, and 366. The sheet feed decks store respective types of printing materials (sheets). Of the printing materials stored in each sheet feed deck, the top printing material is individually separated and conveyed to a conveyance path 303.

The printing unit 107 is capable of automatically obtaining the size of the sheets stored in each sheet feed deck by reading the position of a guide (not illustrated) in the sheet feed deck with a sensor provided to the sheet feed deck. The printing unit 107 obtains other information from the user selecting and inputting it on a screen for changing sheet information to be described later. Incidentally, in the present embodiment, an example in which the printing unit 107 automatically obtains only the sheet size among pieces of sheet information has been described, but the sheet information to be automatically obtained is not limited to the above example. For example, the present embodiment may employ a configuration which obtains sheet information other than the sheet size based on an image obtained by feeding a single sheet stored in the sheet feed deck and reading it with a reading apparatus to be described later.

Also, image forming stations 304 to 307 each include a photosensitive drum (photosensitive body) and form a toner image on the photosensitive drum with a toner of a color different from the others'. Specifically, the image forming stations 304 to 307 use yellow (Y), magenta (M), cyan (C), and black (K) toners to form toner images, respectively.

Toner images of these colors formed by the image forming stations 304 to 307 are sequentially transferred onto an intermediate transfer belt 308 so as to be superimposed one on top of another (primary transfer). The toner images transferred onto the intermediate transfer belt 308 are conveyed to a secondary transfer position 309 by rotation of the intermediate transfer belt 308. At the secondary transfer position 309, the toner images are transferred from the intermediate transfer belt 308 onto a printing material conveyed through the conveyance path 303 (secondary transfer). The printing material after the secondary transfer is conveyed to a fixing unit 311. The fixing unit 311 includes a pressing roller and a heating roller. A fixing process is performed in which heat and pressure are applied to the printing material while the printing material passes between these rollers to fix the toner images to the printing material. The printing material having passed the fixing unit 311 is conveyed through a conveyance path 312 to a connecting point 315 between the printing unit 107 and the diagnosis unit 108. A color image is formed (printed) on a printing material in this manner.

Depending on the type of printing material, a further fixing process may be needed. In this case, the printing material having passed the fixing unit 311 is guided to a conveyance path 314 where a fixing unit 313 is provided. The fixing unit 313 performs a further fixing process on the printing material conveyed through the conveyance path 314. The printing material having passed the fixing unit 313 is conveyed to the connecting point 315. Also, in a case where an operating mode for performing double-sided printing is set, the printing material conveyed to the conveyance path 312 or the conveyance path 314 after an image is formed on its first surface is guided into an inversion path 316. The printing material inverted by the inversion path 316 is guided into a double-sided printing conveyance path 317 and conveyed to the secondary transfer position 309. As a result, toner images are transferred onto a second surface of the printing material on the opposite side from the first surface at the secondary transfer position 309. Thereafter, the printing material passes the fixing unit 311 (and the fixing unit 313), so that the formation of a color image on the second surface of the printing material is completed.

After the completion of the image forming by the printing unit 107, the printed printing material is conveyed to the connecting point 315, from which the printed printing material is conveyed into the diagnosis unit 108.

The diagnosis unit 108 includes image reading units 331 and 332 having contact image sensors (CISs) above and below a conveyance path 330 through which the printed printing material from the printing unit 107 is conveyed. The image reading units 331 and 332 are positioned facing each other across the conveyance path 330. The image reading units 331 and 332 are configured to read the upper surface (first surface) and lower surface (second surface) of the printing material, respectively. Incidentally, the image reading units may be include, for example, charge coupled devices (CCDs) or line scan cameras instead of CISs.

The diagnosis unit 108 performs an image diagnosis process (image diagnosis) which determines whether the image forming apparatus 101 has any malfunctioning parts on images printed on the printed printing material conveyed through the conveyance path 330. Specifically, the diagnosis unit 108 performs a reading process of reading the images on the printed printing material being conveyed by using the image reading units 331 and 332 in response to the printed printing material reaching a predetermined position.

The diagnosis unit 108 performs the image diagnosis process based on an instruction to execute it from the user. It is desirable to perform the image diagnosis process, for example, before a printing operation or in a case where printing failures have continuously occurred. The printing material having passed the diagnosis unit 108 is conveyed to the stacker 109.

The stacker 109 includes stack tray 341 as a tray on which to stack printed printing materials conveyed from the diagnosis unit 108 disposed upstream of the tray in the conveyance direction of printed printing materials. The printed printing material having passed the diagnosis unit 108 is conveyed through a conveyance path 344 inside the stacker 109. The printed printing material conveyed through the conveyance path 344 may be guided into a conveyance path 345 to be stacked on the stack tray 341.

The stacker 109 further includes an escape tray 346 as a sheet discharge tray. In the present embodiment, the escape tray 346 is used to discharge printing materials on which are printed test charts used in the image diagnosis by the diagnosis unit 108. The printed printing material conveyed through the conveyance path 344 may be guided into the conveyance path 347 to be conveyed onto the escape tray 346. The printed printing material may be conveyed without being stacked or discharged at the stacker 109, in which case the printed printing material is conveyed through a conveyance path 348 to the finisher 110 at the following stage.

The stacker 109 further includes an inversion unit 349 for inverting the orientation of the printed printing material being conveyed. The inversion unit 349 is used so that a printing material orientation that has been input into the stacker 109 and the orientations of printed printing materials that have been stacked on the stack tray 341 and are to be output from the stacker 109 will be the same, for example. Note that printed printing materials that are not stacked in the stacker 109 but are to be conveyed to the finisher 110 are not subjected to the inversion operation by the inversion unit 349.

The finisher 110 implements a finishing function designated by the user on the printed printing material conveyed from the diagnosis unit 108 disposed upstream of the finisher 110 in the conveyance direction of printed printing materials. In the present embodiment, the finisher 110 has finishing functions such as a stapling function (one- or two-point binding), a punching function (two-or three-hole punching), and a saddle stitch bookbinding function, for example. The finisher 110 includes two sheet discharge trays 351 and 352. The printed printing material conveyed to the finisher 110 is discharged onto the sheet discharge tray 351 through a conveyance path 353 in a case where the finisher 110 performs no finishing process on the printed printing material. The printed printing material conveyed to the finisher 110 is guided to a conveyance path 354 in a case where the finisher 110 performs a finishing process, such as stapling, on the printed printing material. The finisher 110 executes the finishing process, which is designated by the user, on the printed printing material conveyed through the conveyance path 354 by using a finishing process unit 355, and discharges the printed printing material subjected to the finishing process onto the sheet discharge tray 352.

### Functional Arrangement Diagram

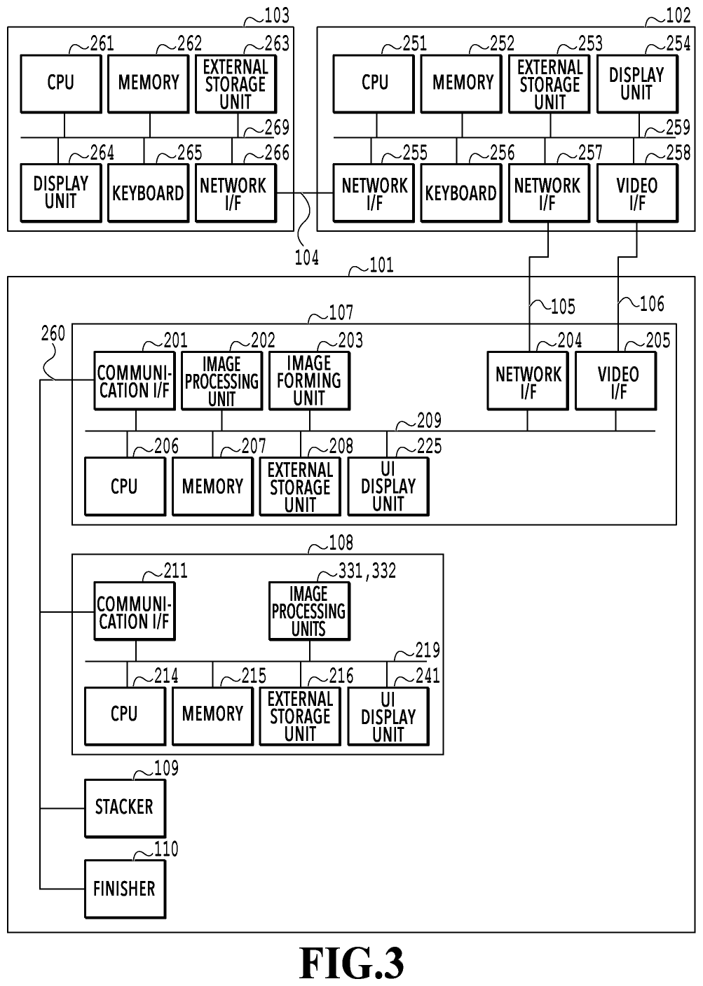

FIG. 3 illustrates example hardware configurations of an information processing apparatus included in the image forming apparatus 101, the external controller 102, and the client PC 103.

The printing unit 107 of the image forming apparatus 101 includes a communication interface (I/F) 201, a network I/F 204, a video I/F 205, a central processing unit (CPU) 206, a memory unit 207, such as a read-only memory (ROM) and a random-access memory (RAM), an external storage unit 208, such as a hard disk drive (HDD) or a solid-state disk (SSD), and a user interface (UI display unit 225. The printing unit 107 further includes an image processing unit 202 and an image forming unit 203. These are connected through a system bus 209 so as to be capable of transmitting and receiving data to and from one another. The communication I/F 201 is connected to the diagnosis unit 108, the stacker 109, and the finisher 110 through a communication cable 260. The CPU 206 performs communication for controlling each apparatus via the communication I/F 201. The network I/F 204 is connected to the external controller 102 through the internal LAN 105 and is used in communication of control data and the like. The video I/F 205 is connected to the external controller 102 through the video cable 106 and is used in communication of data such as image data. Note that the printing unit 107 (image forming apparatus 101) and the external controller 102 may be connected only by the video cable 106 as long as the external controller 102 is capable of controlling operation of the image forming apparatus 101. The external storage unit 208 stores various programs or data. The CPU 206 comprehensively controls operation of the printing unit 107 by executing programs stored in the external storage unit 208. The memory unit 207 stores programs and data which the CPU 206 needs to perform various processes. The memory unit 207 also functions as a work area for the CPU 206. The UI display unit 225 is used to accept input of various settings and operation instructions from the user, and display various information such as setting information and processing statuses of print jobs. For example, the UI display unit 225 accepts various instructions from the user such as diagnosis execution instructions, diagnosis settings, and sheet information settings.

The diagnosis unit 108 includes a communication I/F 211, a CPU 214, a memory unit 215, such as a ROM and a RAM, an external storage unit 216, such as an HDD or an SSD, the image reading units 331 and 332, and a UI display unit 241. These devices are connected through a system bus 219 so as to be capable of transmitting and receiving data to and from one another. The communication I/F 211 is connected to the printing unit 107 through the communication cable 260. The CPU 214 performs communication necessary for controlling the diagnosis unit 108 via the communication I/F 211. The CPU 214 controls operation of the diagnosis unit 108 by executing a control program stored in the memory unit 215. The memory unit 215 stores the control program for the diagnosis unit 108. The image reading units 331 and 332 read images on printing materials conveyed thereto in accordance with an instruction from the CPU 214. Based on the images read by the image reading units 331 and 332, which are images for diagnosis, the CPU 214 diagnoses whether the image forming apparatus 101 has any malfunctioning parts. The UI display unit 241 is used to display diagnosis results, setting screens, and so on. Functioning also as an operation unit, the UI display unit 241 is operated by the user and accepts various instructions from the user such as an instruction to change settings of the diagnosis unit 108 and an instruction to execute an image diagnosis, for example. The external storage unit 216 stores various setting information and image data necessary for image diagnosis. The various setting information and image data stored in the external storage unit 216 are reusable.

The external controller 102 includes a CPU 251, a memory unit 252, such a ROM and a RAM, an external storage unit 253, a keyboard 256, a display unit 254, a network I/Fs 255 and 257, and a video I/F 258. These devices are connected through a system bus 259 so as to be capable of transmitting and receiving data to and from one another. The CPU 251 executes programs stored in the external storage unit 253 to comprehensively control operation of the external controller 102, such as receiving print data from the client PC 103, performing a routing information protocol (RIP) process, and transmitting the print data to the image forming apparatus 101, for example. The memory unit 252 stores programs and data which the CPU 251 needs to perform various processes. The memory unit 252 also functions as a work area for the CPU 251.

The external storage unit 253 stores various programs and data. The keyboard 256 is used by the user to input instructions to operate the external controller 102. The display unit 254 is, for example, a display and used to display information of applications being run on the external controller 102 and operation screens. The network I/F 255 is connected to the client PC 103 via the external LAN 104 and is used in communication of data such as print instructions. The network I/F 257 is connected to the image forming apparatus 101 through the internal LAN 105 and is used in communication of data such as print instructions. The external controller 102 is configured to be capable of communicating with the printing unit 107, the diagnosis unit 108, the stacker 109, and the finisher 110 through the internal LAN 105 and the communication cable 260. The video I/F 258 is connected to the image forming apparatus 101 through the video cable 106 and is used in communication of data, such as image data (print data).

The client PC 103 includes a CPU 261, a memory unit 262, such as a ROM and a RAM, an external storage unit 263, a display unit 264, a keyboard 265, and a network I/F 266. These devices are connected through a system bus 269 so as to be capable of transmitting and receiving data to and from one another. The CPU 261 controls operations of the devices through the system bus 269 by executing programs stored in the external storage unit 263. This enables the client PC 103 to implement various processes. For example, by executing a document processing program stored in the external storage unit 263, the CPU 261 generates print data and issues a print instruction. The memory unit 262 stores programs and data which the CPU 261 needs to perform various processes. The memory unit 262 also functions as a work area for the CPU 261.

The external storage unit 263 stores various applications such as the document processing program, programs such as a printer driver, and various data, for example. The display unit 264 is, for example, a display and used to display information of applications being run on the client PC 103 and operation screens. The keyboard 265 is used by the user to input instructions to operate the client PC 103. The network I/F 266 is communicatively connected to the external controller 102 through the external LAN 104. The CPU 261 communicates with the external controller 102 through the network I/F 266.

### Test Chart Image Diagnosis Process

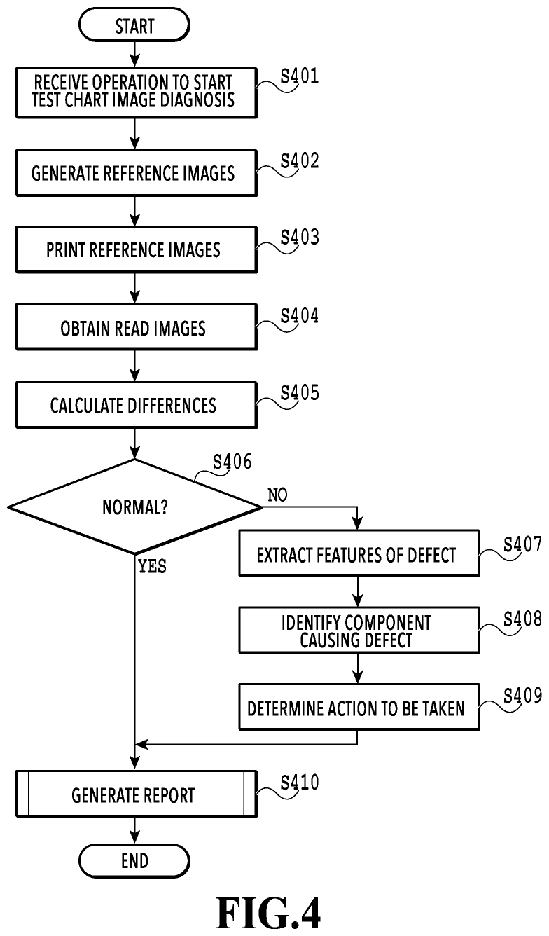

FIG. 4 is a flowchart for describing processing of an image diagnosis using test chart images (hereinafter referred to as “test chart image diagnosis”) according to the present embodiment. The flowchart illustrated in FIG. 4 includes a printing process executed by the printing unit 107 and an image diagnosis process executed by the diagnosis unit 108, and illustrates the flow of the entire process from operations before the start of the image diagnosis to the execution of the diagnosis. The letter “S” in the description of the flowchart represents a step. This applies also to the description of the subsequent flowcharts. The CPU 206 of the printing unit 107 and the CPU 214 of the diagnosis unit 108 execute the processes of the steps in FIG. 4. Note that the test chart images in the present embodiment only need to be images with which print defects can be detected and which include no confidential information.

In S401, the printing system 100 accepts a user instruction to start a test chart image diagnosis from the user or a serviceman of the image forming apparatus 101 via the UI display unit 241 serving also as an operation unit. In the present embodiment, the timing for starting the image diagnosis process is, for example, after a start-up in which the main body is powered on. After the start-up, a notification that prompts start of the diagnosis is displayed on one or more of the UI display unit 241, the display unit 254 of the external controller 102, and the UI display unit 225 of the printing unit 107 to give an instruction to start the diagnosis. The timing for starting the image diagnosis process is not limited to the above one example. In a case where the printing system 100 also has an inspection function of inspecting the presence of print defects on a printed printing material, the printing system 100 may prompt start of the image diagnosis process if successively finding defects by the inspection function. Further, the configuration may be such that a timer is set at a time other than the start-up of the main body at which to display the notification that prompts execution of the image diagnosis process, and the notification is displayed at the set time.

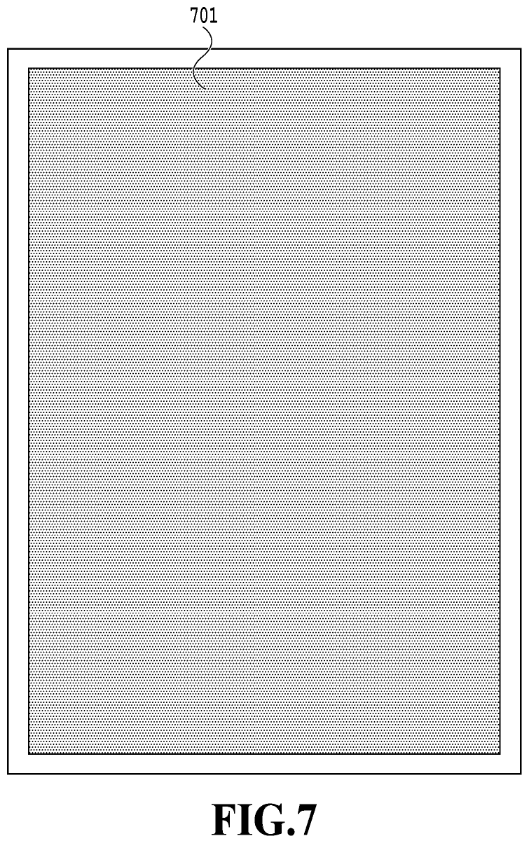

In S402, the CPU 251 of the external controller 102 reads out image data of the test charts saved in advance, rasterizes the image data into bitmap data, and sets the rasterized bitmap data as reference image data. The test chart image data is image data for diagnosing whether the image forming apparatus has any malfunctions. FIG. 7 is a view illustrating an example of a test chart image used in the image diagnosis process in the present embodiment. An image region 701 is where an image is formed with a color material. For example, using a monochromatic image with an areal ratio of 50%, one type of monochromatic test chart image is printed in each of the colors of C, M, Y, and K, that is, a total of four types of test chart images are printed. The CPU 251 transmits the bitmap data obtained by rasterizing the test chart image data to the video I/F 205 of the printing unit 107 from the video I/F 258 through the video cable 106.

In S403, the CPU 206 of the printing unit 107 performs a halftone process on the bitmap data of the test chart image data received at the video I/F 205, and performs printing based on the image data after the halftone process with the image forming unit 203. Note that the design of the test chart image illustrated in FIG. 7 is an example, and the test chart image is not limited to the above example. The ratio between the image region and the non-image region in each test chart image and the areal ratio may be different, and two or more color materials may be used as long as the difference image to be described later can render print defects apparent.

In S404, the CPU 214 of the diagnosis unit 108 reads the test chart images printed on the printing materials with the image reading units 331 and 332, and obtains the read image data. The read image data is saved to the external storage unit 216 of the diagnosis unit 108 as diagnosis image data.

In S405, the CPU 214 compares the reference image data and the read image data with each other in order to determine whether the printing unit 107 have any malfunctions. In the present embodiment, the CPU 214 compares the reference image data and the read image data to calculate a difference value for each pixel. In a case where the calculated difference value is greater than a preset threshold value, the CPU 214 determines that a defect is present, and stores a value “1” in the corresponding pixel in difference image data. On the other hand, in a case where the calculated difference value is less than the threshold value, the CPU 214 stores a value “0” in the corresponding pixel in the difference image data. Note that the method of generating the difference image data is not limited to the above example. For example, difference values between the read image data and reference image data obtained by calculating the average of pixel values on a pixel-by-pixel basis from multiple pieces of read image data and setting the average values of the pixels as the pixel values of the reference image data may be calculated as the pixel values of the difference image data. In another method, the shapes and colors of defects such as streaks and spots may be saved as feature amounts to the external storage unit 216 in advance, and regions where these feature amounts are detected may be determined to be defects. Also, the diagnosis unit 108 may include a correction unit that corrects a non-linear relationship between the pixel values and luminance values of the read image data obtained by the image reading unit 311, and correct the pixel values of the read image data and then generate the difference image data. The CPU 214 saves the difference image data thus generated, which is formed of pieces of binary data each indicating the presence or absence of a defect, to the external storage unit 216.

In S406, the CPU 214 determines whether the image forming apparatus 101 is normal based on the difference image data. The determination is made based on whether there are any pixels with “1” in the difference image data. If determining that the image forming apparatus 101 is normal (YES in S406), the CPU 214 moves to S410. On the other hand, if determining that the image forming apparatus 101 is not normal (the difference image data includes pixels with the pixel value “1”) (NO in S406), the CPU 214 moves to S407.

In S407, the CPU 214 extracts feature information for identifying the malfunctioning component of the printing unit 107 from the read image data and the difference image data. From the image regions in the read image data corresponding to the defect regions in the difference image data generated in S405, at which the pixel values are “1,” the CPU 214 extracts features of the differences. Examples of the feature information of each defect region obtained by this extraction process include color material information indicating which color component the region includes among yellow, magenta, cyan, and black, and contrast information indicating whether the difference value is a difference in the positive direction or in the negative direction with a positive or negative numeric value. Other examples of the feature information include size information, such as the width (size in the main scanning direction) and height (size in the sub scanning direction) of the defect region, and shape information indicating the shape of the defect region (a spot shape, a vertical streak shape, a horizontal streak shape, or the like). Still other examples of the feature information may be coordinate information indicating the position of the pixel in the test chart image by the printing unit 107 in a direction perpendicular to the conveyance direction, periodicity information indicating the periodic intervals at which defects with similar features appear in the conveyance direction in the test chart image, and the like. These pieces of feature information extracted are saved to the external storage unit 216.

In S408, based on the feature information of the defect regions obtained in S407, the CPU 214 identifies the component causing the image defects among the components of the printing unit 107 and the image reading units 331 and 332. The CPU 214 selects similar regions with highly similar feature information out of the defect regions for each single color, and identifies the malfunctioning component based on the color material information and the periodicity information of the selected similar regions.

In S409, the CPU 214 determines an action to be taken to handle the image defects based on the component causing the image defects identified in S408. The action to be taken can be classified as either an action by which automatic recovery can be achieved or an action by which automatic recovery cannot be achieved. Examples of the action by which automatic recovery can be achieved include actions by which automatic recovery can be achieved in the printing unit 107 such as cleaning wires and grids of corona chargers serving as means for charging the photosensitive drums included in the image forming stations 304 to 307 of the printing unit 107. The following are two examples of the action by which automatic recovery cannot be achieved. One example is an action that requires an operation by the user, such as cleaning the reading glass surfaces of the image reading units 331 and 332 of the diagnosis unit 108 or adjusting the printing materials to be used, an action that requires an operation by a serviceman, such as replacement of components, or the like. The other example is fixing abnormal reading by the image reading units 331 and 332, removing fibers, foreign matter, and the like that have been in the printing material before image forming is performed, replacing the printing materials, or the like. The configuration may be such that, in a case where the action to be taken to handle the image defects determined in S409 is an action by which automatic recovery can be achieved, the CPU 214 executes control to implement the determined action by which automatic recovery can be achieved.

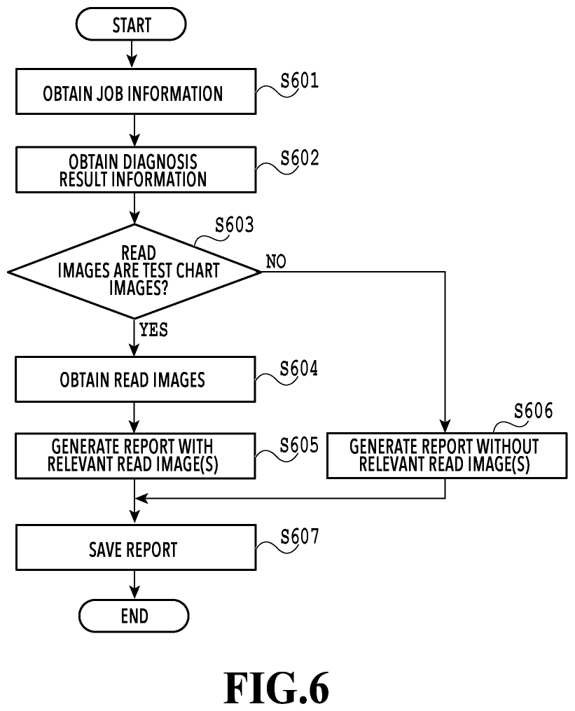

In S410, the CPU 214 generates a diagnosis report indicating the result of the diagnosis using the relevant test chart image(s). Details will be described later using FIG. 6. After the diagnosis report generation process is completed, the test chart image diagnosis process illustrated in FIG. 4 is terminated.

Incidentally, in the present embodiment, the configuration is such that S410 is performed also in a case where it is determined in S406 that no abnormality is present. Alternatively, the configuration may be such that the process is terminated without performing S410, thus generating no diagnosis report, in the case where it is determined in S406 that no abnormality is present.

### User Image Diagnosis Process

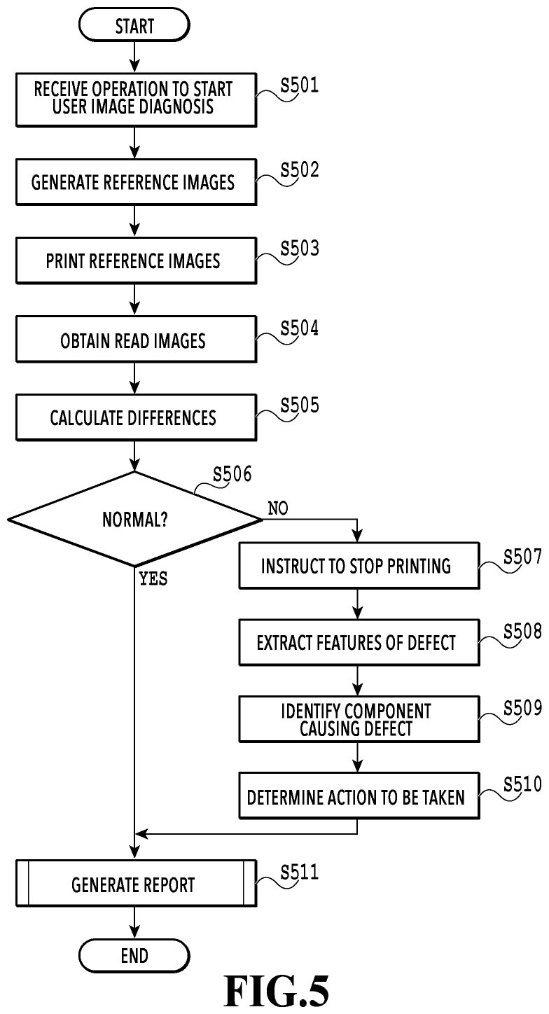

FIG. 5 is a flowchart for describing processing of an image diagnosis using user images (hereinafter referred to as “user image diagnosis”) according to the present embodiment. The flowchart illustrated in FIG. 5 includes a printing process executed by the printing unit 107 and an image diagnosis process executed by the diagnosis unit 108, and FIG. 5 illustrates the flow of the entire process from operations before the start of the image diagnosis to the execution of the diagnosis. The CPU 206 of the printing unit 107 and the CPU 214 of the diagnosis unit 108 execute the processes of the steps in FIG. 5.

In S501, the printing system 100 accepts a user instruction to start a user image diagnosis from the user or a serviceman of the image forming apparatus 101 via the UI display unit 241 serving also as an operation unit. In the present embodiment, the timing for starting the user image diagnosis process is when a print job is executed. Incidentally, the configuration may be such that each print job is provided with a setting item for setting whether to execute the user image diagnosis, and the user image diagnosis is started only in a case where the setting item is enabled. Also, the timing for starting the user image diagnosis process is not limited to the above example, and the configuration may be such that the user image diagnosis is started when proof printing is executed, for example.

In S502, the CPU 251 of the external controller 102 reads out the print image data included in the print job, which has been saved in the printing unit 107, and rasterizes the print image data into bitmap data to generate reference image data. The CPU 251 transmits the bitmap data obtained by rasterizing the print data to the video I/F 205 of the printing unit 107 from the video I/F 258 through the video cable 106. Note that the generation of the reference image data described above is one example. Read image data of the same printed product or image data generated by combining multiple pieces of such read image data may be saved in advance and used as reference image data, for example.

In S503, the CPU 206 of the printing unit 107 performs a halftone process on the bitmap data of the print data received at the video I/F 205, and performs printing based on the image data after the halftone process with the image forming unit 203.

In S504, the CPU 214 of the diagnosis unit 108 reads the images printed on printing materials with the image reading units 331 and 332, and obtains the read image data. The read image data is saved to the external storage unit 216 of the diagnosis unit 108 as diagnosis image data.

In S505, the CPU 214 compares the reference image data and the read image data with each other in order to determine whether the printing unit 107 have any malfunctions. In the present embodiment, the CPU 214 compares the reference image data and the read image data to calculate a difference value for each pixel. In a case where the calculated difference value is greater than a preset threshold value, the CPU 214 determines that a defect is present, and stores a value “1” in the corresponding pixel in difference image data. On the other hand, in a case where the calculated difference value is less than the threshold value, the CPU 214 stores a value “0” in the corresponding pixel in the difference image data. Note that the method of generating the difference image data is not limited to the above example. For example, difference values between the read image data and reference image data obtained by calculating the average of pixel values on a pixel-by-pixel basis from multiple pieces of read image data and setting the average values of the pixels as the pixel values of the reference image data may be calculated as the pixel values of the difference image data. Also, the shapes and colors of defects such as streaks and spots may be saved as feature amounts to the external storage unit 216 in advance, and regions where these feature amounts are detected may be determined to be defects. Also, the diagnosis unit 108 may include a correction unit that corrects a non-linear relationship between the pixel values and luminance values of the read image data obtained by the image reading unit 311, and correct the pixel values of the read image data and then generate the difference image data. The CPU 214 saves the difference image data thus generated, which is pieces of binary data each indicating the presence or absence of a defect, to the external storage unit 216.

In S506, the CPU 214 determines whether the image forming apparatus 101 is normal based on the difference image data. The determination is made based on whether there are any pixels with “1” in the difference image data. If determining that the image forming apparatus 101 is normal (YES in S506), the CPU 214 moves to S511. On the other hand, if determining that the image forming apparatus 101 is not normal (the difference image data includes pixels with the pixel value “1”) (NO in S506), the CPU 214 moves to S507.

In S507, the CPU 214 stops the printing process by the printing unit 107, thereby stopping the inspection.

In S508, the CPU 214 extracts feature amounts for identifying the malfunctioning component of the printing unit 107 from the read image data and the difference image data. From the image regions in the read image data corresponding to the defect regions in the difference image data generated in S505, at which the pixel values are “1,” the CPU 214 extracts features of the differences. Examples of the feature information of each defect region obtained by this extraction process include color material information indicating which color component the region includes among yellow, magenta, cyan, and black, and contrast information indicating whether the difference value is a difference in the positive direction or in the negative direction with a positive or negative numeric value. Other examples of the feature information include size information, such as the width (size in the main scanning direction) and height (size in the sub scanning direction) of the defect region, and shape information indicating the shape of the defect region (a spot shape, a vertical streak shape, a horizontal streak shape, or the like). Still other examples of the feature information include coordinate information indicating the position of the pixel in the user image by the printing unit 107 in a direction perpendicular to the conveyance direction, periodicity information indicating the periodic intervals at which defects with similar features appear in the conveyance direction in the user image, and the like. The pieces of feature information extracted are saved to the external storage unit 216.

In S509, based on the feature information of the defect regions obtained in S506, the CPU 214 identifies the component causing the image defects among the components of the printing unit 107 and the image reading units 331 and 332. The CPU 214 selects similar regions that have high degrees of similarity in density and positional distribution out of the defect regions for each single color, and identifies the malfunctioning component based on the color material information and the periodicity information of the selected similar regions.

In S510, the CPU 214 determines an action to be taken to handle the image defects based on the component causing the image defects identified in S509. The action to be taken to handle the image defects can be classified as either an action by which automatic recovery can be achieved or an action by which automatic recovery cannot be achieved. Examples of the action by which automatic recovery can be achieved include actions by which automatic recovery can be achieved in the printing unit 107 such as cleaning wires and grids of corona chargers serving as means for charging the photosensitive drums included in the image forming stations 304 to 307 of the printing unit 107. The following are examples of the action by which automatic recovery cannot be achieved. One example is an action that requires an operation by the user, such as cleaning the reading glass surfaces of the image reading units 331 and 332 of the diagnosis unit 108 or adjusting the printing materials to be used, an action that requires an operation by a serviceman, such as replacement of components, or the like. Another example is an action to handle abnormal reading by the image reading units 331 and 332, fibers, foreign matter, and the like that have been in the printing material before image forming is performed, or the like. The configuration may be such that, in a case where the action to be taken to handle the image defects determined in S510 is an action by which automatic recovery can be achieved, the CPU 214 executes control to implement the determined action by which automatic recovery can be achieved.

In S511, the CPU 214 generates a diagnosis report indicating the result of the diagnosis using the relevant user image(s). Details will be described later using FIG. 6. After the diagnosis report generation process is completed, the user image diagnosis process illustrated in FIG. 5 is terminated.

Incidentally, in the present embodiment, the configuration is such that S511 is performed also in a case where it is determined in S506 that no abnormality is present. Alternatively, the configuration may be such that the process is terminated without performing S511, thus generating no diagnosis report, in the case where it is determined in S506 that no abnormality is present.

### Diagnosis Report Generation Process

The diagnosis report generation process according to the present embodiment will now be described using a drawing. FIG. 6 is a flowchart illustrating a procedure of the diagnosis report generation process executed by the diagnosis unit 108. The CPU 214 of the diagnosis unit 108 executes the processes of the steps in FIG. 6.

In S601, the CPU 214 obtains print job information that includes at least part of the print job subjected to diagnosis. The print job information in the present embodiment includes model information of the image forming apparatus 101 and image type information indicating whether the print image data is test chart image data, among the pieces of information included in the print job that are saved in the printing unit 107. The image type information can be flag information indicating whether the print image data included in the print job is test chart image data, or a name of the print image data (data name). In a case where the image type information is the flag information, the flag information is set in the print job in response to acceptance of a user instruction to perform the test chart image diagnosis or the user image diagnosis from a serviceman. The flag information may be set also in a case where predetermined image data (test chart image data) held in the diagnosis unit 108 in advance is used as the print image data. In a case where the image type information is the name of the print image data, a predetermined character string is saved to the external storage unit 216 in advance, for example, so that the print image data can be determined to be test chart image data in a case where that predetermined character string is detected from the name of the print image data.

Also, in a case where the print image data is user image data, the print job information includes a print job name and sheet size designated by the user. In a case where the print image data is test chart image data, the print job name does not need to be obtained as the print job information. In a case where the print job name is not obtained but a job name needs to be displayed, the job name field may be left blank or a predetermined name saved in the external storage unit 216 or the like may be used.

In S602, the CPU 214 obtains diagnosis result information. The diagnosis result information in the present embodiment can be the feature information, the information indicating the cause of the image defects, and the information indicating the determined action to be taken that are obtained in S407 to S409 in the test chart image diagnosis process or in S508 to S510 in the user image diagnosis process. Incidentally, the diagnosis result information may be only the feature information in a case of generating a brief diagnosis report on only the defects on the printed product.

In S603, the CPU 214 determines whether the diagnosis result information obtained in S602 is information obtained by the test chart image diagnosis or information obtained by the user image diagnosis based on the image type information included in the print job information obtained in S601. Specifically, the CPU 214 proceeds to S604 if the read image data is test chart image data obtained by the test chart image diagnosis, and proceeds to S606 if the read image data is user image data, not test chart image data.

In S604, the CPU 214 obtains the read image data that was compared with the reference image data in the test chart image diagnosis performed to obtain the diagnosis result information obtained in S602. Specifically, the CPU 214 obtains the read image data obtained in S404 in the test chart image diagnosis process illustrated in FIG. 4.

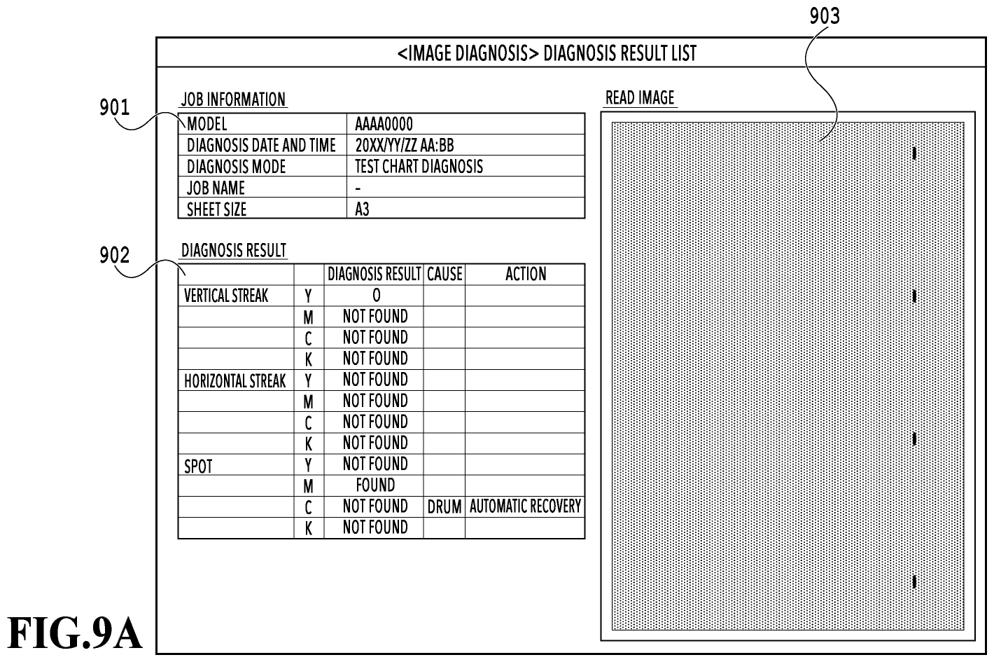

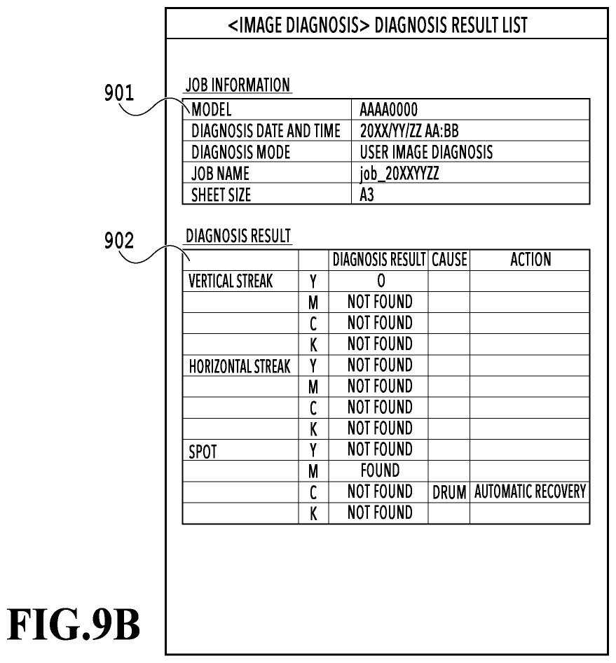

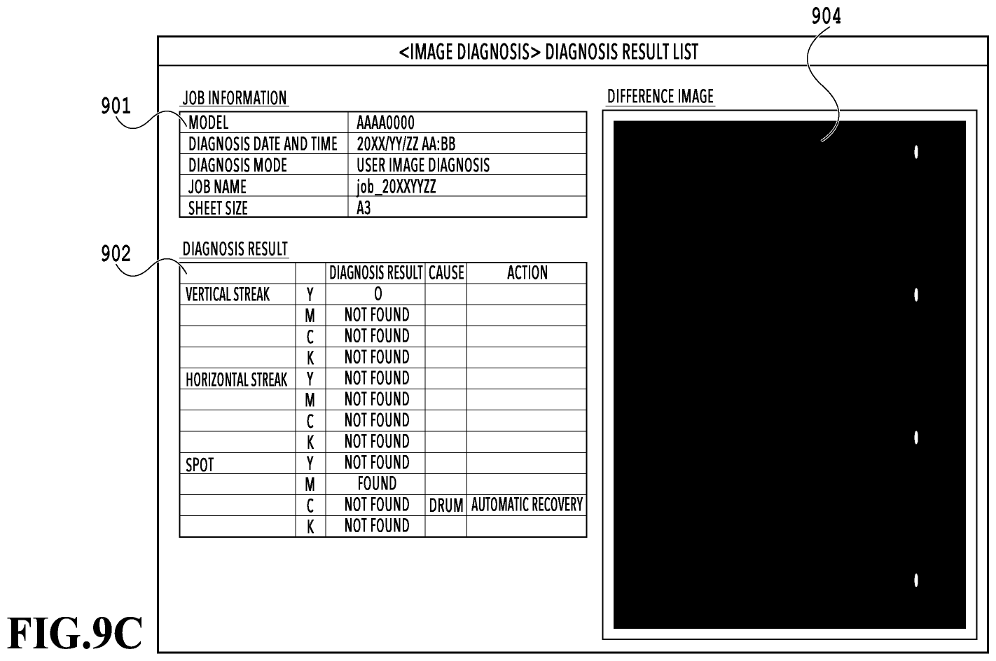

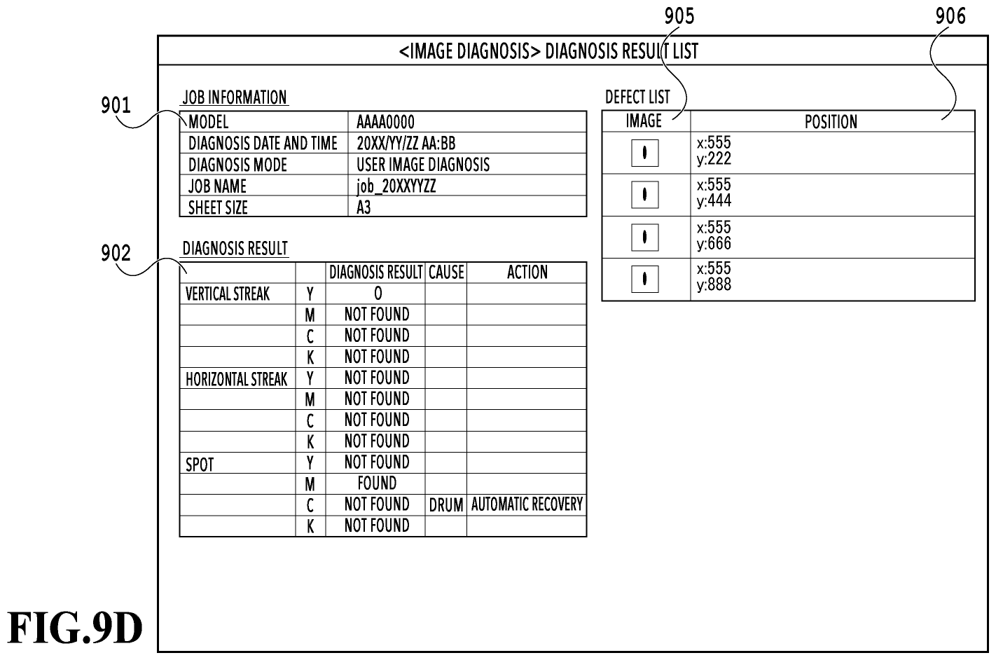

In S605, the CPU 214 generates a diagnosis report with the relevant read image(s). The diagnosis report is generated in a predetermined format, such as the Portable Document Format (PDF), for example. The diagnosis report with the relevant read image(s) includes the print job information obtained in S601, the diagnosis result information obtained in S602, and the read image data obtained in S604. The diagnosis report illustrated in FIG. 9A is an example of the diagnosis report with the relevant read image(s) and includes print job information 901, diagnosis result information 902, and read image data 903.

Note that the contents of the diagnosis report illustrated in FIG. 9A are one example, and parameters used in the diagnosis, such as threshold value information used in the calculation of the difference values between the reference image data and the read image data, may be described, for example. Also, the format of the diagnosis report is not limited to PDF, and the print job information and the diagnosis result information may be generated in the Comma-Separated Values (CSV) format, and the bitmap image data obtained by rasterizing the read image data may be included, for example.

In S606, the CPU 214 generates a diagnosis report without the relevant read image(s). The diagnosis report is generated in a predetermined format, such as PDF. The print job information obtained in S601 and the diagnosis result information obtained in S602 are described in the diagnosis report without the relevant read image(s). The diagnosis report illustrated in FIG. 9B is one example of the diagnosis report without the relevant read image(s), and does not include the print job information 901, the diagnosis result information 902, or the read image data.

Note that the contents described in FIG. 9B are one example. A message indicating that the report does not include the read image data due to the diagnosis being a user image diagnosis may be displayed, for example. Also, the format of the diagnosis report is not limited to PDF, and the print job information and the diagnosis result information may be generated in the CSV format, for example.

In S607, the CPU 214 saves the generated diagnosis report to the external storage unit 216 and terminates the process.

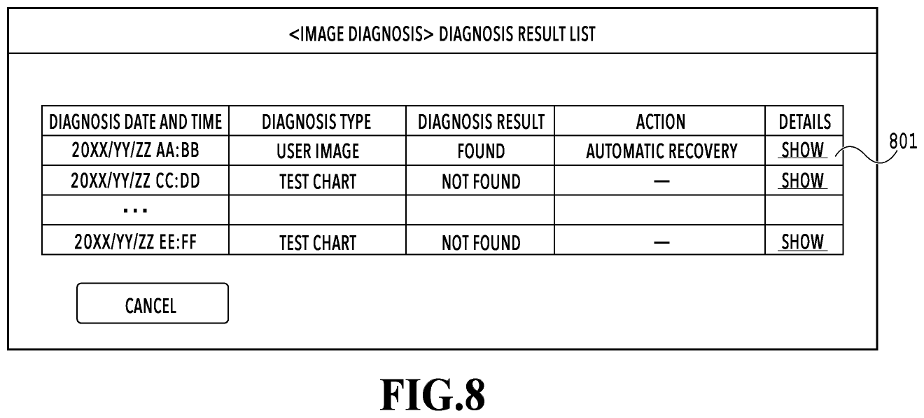

Note that it is desirable to display diagnosis reports in the form of a list as illustrated in FIG. 8 on the UI display unit 241 based on the user's instruction so that the user can check a list of diagnosis results. For example, a display button 801 for displaying details prepared for each diagnosis report as illustrated in FIG. 8 may be pressed to display details of a diagnosis report as illustrated in FIG. 9A or 9B on the UI display unit 241.

Also, in the case of generating a diagnosis report with the relevant read image(s) in S605, the job name may be listed and, in the case of generating a diagnosis report without the relevant read image(s) in S606, no job name may be listed.

As described above, according to the present embodiment, it is possible to include test chart image data in a diagnosis report and not include user image data in a diagnosis report through simple operations. Also, in a case of using a name of test chart image data as image type information, it is possible to automatically include the test chart image data in a diagnosis report and not include user image data in a diagnosis report. That is, according to the present embodiment, it is possible to include test chart image data in a diagnosis report while eliminating security concerns without increasing the user's effort.

### Modifications of First Embodiment

Note that the present embodiment has described an example in which a diagnosis report without a relevant read image(s) is generated for a user image diagnosis. However, the technique of the present disclosure is not limited to the above configuration. For example, the configuration may be such that, for a user image diagnosis, alternative image data that replaces the read image data is automatically generated and the generated image data is included in the diagnosis report. The diagnosis report illustrated in FIG. 9C represents an example of including difference image data 904 in place of read image data. The diagnosis report illustrated in FIG. 9D represents an example of including pieces of partial image data 905 obtained by cropping defect regions in place of the read image data. For each piece of partial image data 905, a position 906 indicating its coordinates in the read image data is listed. Also, the image data to be used in place of the read image data may be redacted image data being the read image data subjected to image processing that renders designs and characters in the original read image data unidentifiable, such as a smoothing process (redaction process).

### Second Embodiment

An image diagnosis process according to a second embodiment will now be described. The first embodiment has described an example in which a diagnosis report without read image data is generated for a user image diagnosis. In contrast, in the second embodiment, a diagnosis report without read image data is generated in a case where the diagnosis report is for a user image diagnosis and the transmission destination for the diagnosis report is outside the range of a predetermined address. For example, the configuration can be such that a diagnosis report without read image data is generated only in a case of transmitting diagnosis reports with user image data are set to be transmitted to the outside of the diagnosis unit 108 through the external LAN 104.

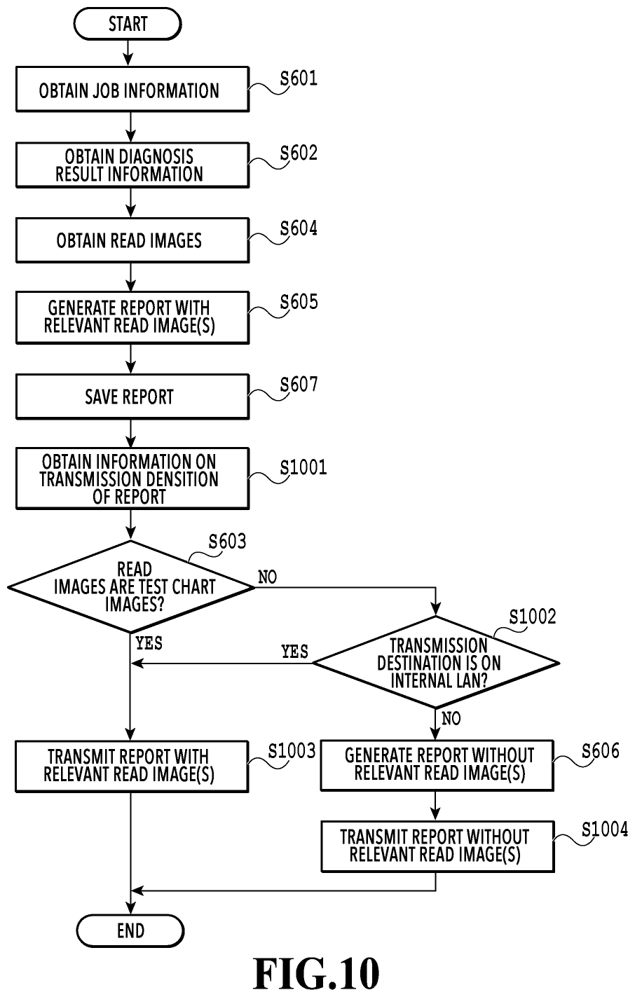

FIG. 10 is a flowchart describing a procedure of the diagnosis report generation process executed by the diagnosis unit 108 according to the second embodiment. The CPU 214 of the diagnosis unit 108 executes the processes of the steps illustrated in FIG. 10. Note that, for the same processes as the processes illustrated in FIG. 6 described earlier, the same reference signs will be used, and detailed description thereof will be omitted. In the present embodiment, a diagnosis report is saved to the external storage unit 216 of the diagnosis unit 108 and, in a case of transmitting the diagnosis report to the outside of the image forming apparatus 101, whether to include the read image data in the diagnosis report is switched depending on the transmission destination for the diagnosis report.

In the present embodiment, the CPU 214 firstly performs the processes of S601, S602, S604, S605, and S607 to generate and save a diagnosis report with the read image data, and proceeds to S1001.

In S1001, the CPU 214, for example, accepts an instruction to transmit the diagnosis report from the user via the UI display unit 241, obtains information on the transmission destination for the diagnosis report, and proceeds to S603.

If the read image data is test chart image data in S603, the CPU 214 proceeds to S1003. If the read image data is not test chart image data, the CPU 214 proceeds to S1002.

In S1002, the CPU 214 determines whether the transmission destination for the diagnosis report is a predetermined address, which is an address on the internal LAN 105 in the present embodiment. The CPU 214 proceeds to S1003 if the transmission destination is on the internal LAN 105, and proceeds to S606 if the transmission destination is an address on a network other than the internal LAN 105, e.g., the address of the client PC 103 on the external LAN 104.

In S1003, the CPU 214 transmits the diagnosis report with the read image data saved in S607 to the transmission destination.

In S606, the CPU 214 generates a diagnosis report without the read image data and proceeds to S1004.

In S1004, the CPU 214 transmits the diagnosis report without the read image data generated in S606 to the transmission destination.

In the above example, whether to include read image data in a diagnosis report is switched depending on whether its transmission destination is within a predetermined network, i.e., whether the transmission destination is within a predetermined address range. However, the criterion for switching whether to include read image data is not limited to this. For example, the configuration may be such that whether to include read image data is switched depending on whether the transmission destination is a pre-registered address or depending on the authority to access to the transmission destination. Specifically, the read image data is included in a case where only the user can access the transmission destination, and the read image data may not be included in a case where servicemen can also access the transmission destination.

As described above, in the present embodiment, whether to include read image data in a diagnosis report is switched depending on the transmission destination of the diagnosis report. That is, it is possible to generate a diagnosis report with test chart image data while eliminating a security concern that diagnosis reports with user image data may be transmitted to the outside, without increasing the user's effort.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the technique of the present disclosure, it is possible to switch whether to display or not to display read image data in a diagnosis report without increasing the user's effort.

This application claims the benefit of Japanese Patent Application No. 2024-077292 filed May 10, 2024, which is hereby incorporated by reference wherein in its entirety.

1. An information processing apparatus comprising:
an obtaining unit that obtains read image data obtained by reading a printed product printed by a printing apparatus based on print image data included in a print job, and at least part of a print job;
a diagnosis unit that makes a diagnosis on whether the printed product has a defect based on the read image data; and
a generation unit that generates a diagnosis report indicating a result of the diagnosis based on the at least part of the print job obtained by the obtaining unit, wherein
the diagnosis report includes the read image data in a case where the print image data is predetermined image data for detecting a print defect and does not include the read image data in a case where the print image data is not the predetermined image data.

2. The information processing apparatus according to claim 1, wherein
the at least part of the print job obtained by the obtaining unit includes a data name of the print image data, and
the predetermined image data is image data including a predetermined character string in the data name.

3. The information processing apparatus according to claim 1, wherein
the at least part of the print job obtained by the obtaining unit includes image type information indicating whether the read image data is the predetermined image data, and
the predetermined image data is image data indicated as the predetermined image data by the image type information.

4. The information processing apparatus according to claim 3, further comprising an acceptance unit that accepts a user instruction, wherein
the acceptance unit sets the image type information in the print job based on the user instruction.

5. The information processing apparatus according to claim 1, wherein the predetermined image data is image data held by the information processing apparatus.

6. The information processing apparatus according to claim 1, wherein the predetermined image data is test chart image data.

7. The information processing apparatus according to claim 1, wherein
the at least part of the print job obtained by the obtaining unit includes model information of the printing apparatus, and
the diagnosis unit diagnoses whether the printing apparatus has a malfunction based on the model information.

8. The information processing apparatus according to claim 1, wherein in the case where the print image data is not the predetermined image data, the diagnosis report includes difference image data representing a difference from reference image data corresponding to the read image data, partial image data obtained by cropping an image region in the read image data corresponding to the defect, and redacted image data obtained by performing a redaction process on the read image data.

9. An information processing apparatus comprising:
an obtaining unit that obtains read image data obtained by reading a printed product output by a printing apparatus, and at least part of a print job for the printed product;
a diagnosis unit that makes a diagnosis on whether the printed product has a defect based on the read image data; and
a generation unit that generates a diagnosis report indicating a result of the diagnosis based on the at least part of the print job obtained by the obtaining unit, wherein
the diagnosis report includes the read image data in a case where a transmission destination for the diagnosis report is within a range of a predetermined address for detecting a print defect and does not include the read image data in a case where the transmission destination for the diagnosis report is outside the range of the predetermined address.

10. The information processing apparatus according to claim 9, wherein
the at least part of the print job includes an address of the transmission destination for the diagnosis report, and
the range of the predetermined address is an inside of a predetermined network.

11. An information processing method comprising:
obtaining read image data obtained by reading a printed product printed by a printing apparatus based on print image data included in a print job, and at least part of a print job;
making a diagnosis on whether the printed product has a defect based on the read image data; and
generating a diagnosis report indicating a result of the diagnosis based on the at least part of the print job obtained by the obtaining, wherein
the diagnosis report includes the read image data in a case where the print image data is predetermined image data for detecting a print defect and does not include the read image data in a case where the print image data is not the predetermined image data.
